(19) United States
(12) Patent Application Publication
(10) Pub. No.: US 2018/0114433 A1
(43) Pub. Date: Apr. 26, 2018

(54) SRH (Smartphone Remote Help)

(71) Applicant: Evelyn Martinez, Bronx, NY (US)

(72) Inventor: Evelyn Martinez, Bronx, NY (US)

(21) Appl. No.: 15/726,249

(22) Filed: Oct. 5, 2017

Related U.S. Application Data
(63) Continuation of application No. 15/530,712, filed on Feb. 18, 2017, now abandoned.
(60) Provisional application No. 62/389,237, filed on Feb. 22, 2016.

(51) Int. Cl. G08C 17/02; H04M 1/725

(52) U.S. Cl. CPC G08C 17/02; H04M 1/7253

(57) ABSTRACT

Smartphones have always been operated by the User in a physical hands on way with the SRH (Smartphone Remote Help) certain phone features/functions will be remotely controlled from a short distance thus allowing for a special convenience factor for the Owner. The SRH through its unique setup and programming will allow for a Smartphone's power to be turned on and off, phone's volume turned up or down, music source (up to 3) to be made to play and then stopped if desired and will be able to send a signal to the phone in order to locate it if out of sight at which time the SRH will make the phone emit a unique sound in order to be able to locate it and can charge the phone as well.

On Feb. 22, 2016, a Provisional patent application (PPA) was Filed by this Inventor for the SRH (Smartphone Remote Help). The Application No. 62/389,237 was assigned to the Inventor's (PPA). The PPA was signed and dated by the Inventor on Feb. 20, 2016 and then mailed to the USPTO which when received Feb. 22, 2016 was then filed.

### BACKGROUND OF THE INVENTION

Desktop Computers, Tablets, Smartphones are some of today's electronic devices that have many accessories created for them for the convenience and practical uses of the Owner's of these devices but enjoyability is not the only purpose of accessories and it is here where this Inventor's Smartphone Remote Help (SRH) will be of service to one of these devices the Smartphone.

The Smartphone has been exclusively sold as one Unit. The Smartphone is hardware (a device) and contains programs, apps and the functions that allows it to be the intended product too a phone. The SRH (Smartphone Remote Help) is a hardware programmed device that will complement Smartphones as an accessory and will perform certain functions.

Televisions, Car and Home Stereos, some Toys and Drones all have Remote Controls with Hardware and Software that allows the User to control their device. The convenience of remote controls is immense to society these days as it helps User's control their devices at ease.

### BRIEF SUMMARY OF INVENTION

The Smartphone Remote Help (SRH) unit will serve to assist Smartphones by allowing the User to access certain phone features via the Remote (hardware) and its programmed (Software) components which would allow for the operation of the User's device (their Smartphone) wirelessly from a short distance.

Almost all electronic devices and appliances include a remote control unit except for Smartphones (Mobile phones) and with the unique features of the SRH (Smartphone Remote Help) that would change.

A few years ago, around the early 2010's, manufacturers of Smartphones began incorporating infrared emitters in their Smartphones in order to allow the device to become a Remote Control via a downloadable app or one that's included in which the User can then control remotely certain other User's devices. This is not the function or features the SRH will have and provide. It is a whole separate unit that will connect a Smartphone via Software technology and an app and on a limited bases control the Smartphone device for the purpose of allowing the User the choice not to have to pick up the Mobile phone itself if the User's desire is to enable a mobile phone feature remotely that will be already pre-programmed by Software Technology and that is what the SRH (Smartphone Remote Help) will be able to achieve.

### BRIEF DESCRIPTION OF DRAWINGS

FIG. 1—Illustrates the hardware side of the SRH (Smartphone Remote Help) that will be uniquely paired with a Smartphone.

FIG. 2—Illustrates the SRH hardware unit and its detachable feature. The SRH detachable attachment (SRHc) is shown out of its slots located in the back of the SRH and will be able to in a limited capacity charge a mobile phone. The unit will display a green light when it is charging the mobile phone and no light when it has run out of charge.

FIG. 3—Illustrates a User utilizing the SRH by pointing it at the Smartphone in order to connect with it remotely.

FIG. 4—Illustrates the different features the SRH will be able to control on the Smartphone via Software Technology and app (application) remotely.

FIG. 5—Illustrates the SRH charging (USB) input port that is built into the SRH in order to be able to charge it. It also shows where a small red light will turn on when the SRH is being charged and a green light when it is fully charged. The attached SRHc is also illustrated with its independent USB output and input ports and its charging on/off indicator light.

FIG. 6—Illustrates the SRH connecting to a Smartphone via an SRH Application, Bluetooth technology and Coded software.

### DETAILED DESCRIPTION OF THE INVENTION

Smartphones have not been partnered with an accessory that complements them by allowing the User to turn on and off the mobile phone's music sources, control the phone's volume, allow the phone to emit a sound when the remote is activated in order to search for an out of sight phone, power the phone on and off and charge the phone with a limited charging unit that's attached to a remote via a slot in the back of the remote. The SRH and its attached SRHc will be such an accessory to Smartphones and will be able to provide the functions described herein.

The Inventor is describing these functions as individual functions that will be carried out by the Smartphone Remote Help (SRH) and (SRHc) a 2 piece electronic hardware device that uses modern Software Technology that is pre-programmed into the SRH and assisted by an application unique to the SRH. The SRH will pair with a mobile phone capable of pairing up with such software technology in existence already as Bluetooth technology to carry out certain functions but also will operate on technology run through its own application.

The SRH will also function as a limited charging unit for the mobile smartphone by including a small charging unit device the SRHc that is charged independently from the SRH and then adheres to the back of the SRH in a built-in slot where it stays charged and ready for the User if and when the User finds him or herself in a need for a battery charge. A green light will turn on when the charging unit SRHc is charging and when it has been depleted of its charge the light will no longer be visible.

Bluetooth technology is a wireless standard whereas data can be exchanged over short distances utilizing short-wavelength (UHF) radio waves. The technology is compatible with hardware such as mobile phones, personal computers as well as other types of hardware. The Smartphone Remote Help (SRH) will adhere to the Bluetooth SIG industry standard in order to market the SRH as a Bluetooth device but does not limit itself to that technology only in order to be able to perform as a Remote Control device able to independently operate at a distance a Smartphone that has been assigned to a specific SRH.

The SRH will charge by plugging into a wall outlet via a USB micro cable exactly as the one's used by mobile phones. The SRHc will charge independently from the SRH it sits in as it will contain its own charging port to also be used with a USB micro cable that will plug into a wall outlet as well. The SRH will have its own input port for charging purposes and the SRHc will have both an output port for charging a mobile phone and an input port in order to be able to charge the SRHc.

The Disclosure the Inventor (myself) is presently disclosing herein is an exemplification of the Invention and is not to be considered or intended to make the Invention limited to the specific features, use, method illustrated by figures or description hereby presented below.

The Invention presented herein will be described now by referencing the appended figures.

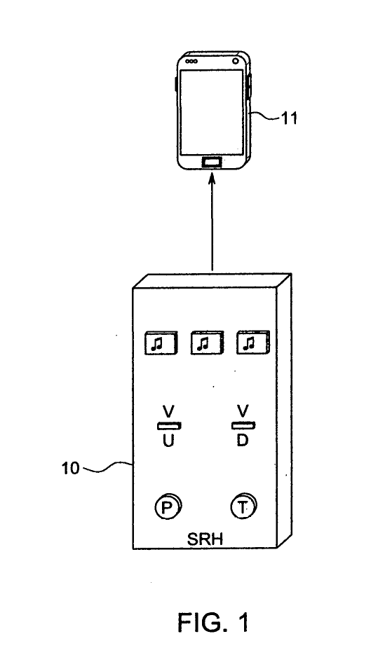

FIG. 1 illustrates the SRH (Smartphone Remote Help) hardware 10 and the device 11 it will service a mobile phone remotely.

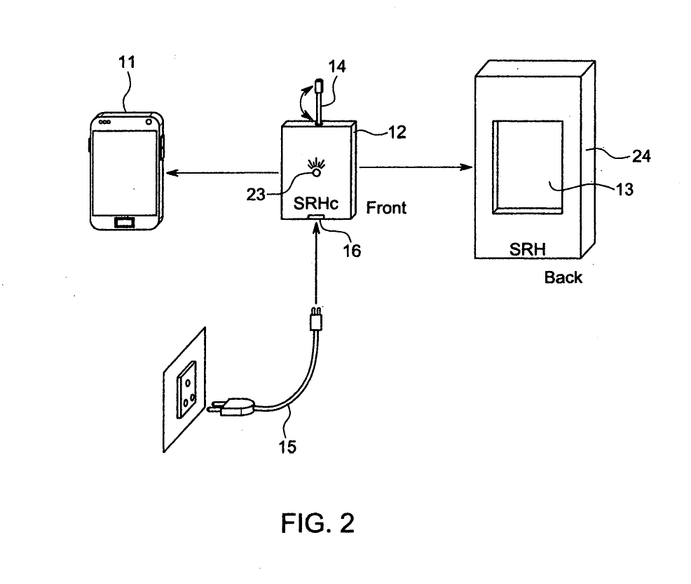

FIG. 2 illustrates the backside of the SRH 24 and the unique slot 13 that will house the SRHc 12 a charging device for a mobile phone. FIG. 2 also shows the output port 14 of the SRHc 12 and its built-in USB micro cable 14 wherefore a User can charge on a limited capability their mobile phone 11. The SRHc 12 also has a USB input port 16 where a micro USB wall connector 15 can be used to charge the SRHc. FIG. 2 also shows that SRHc 12 has a charging light indicator 23 that turns on when the SRHc 12 is charging and turns off when it's done charging the mobile phone 11 it services.

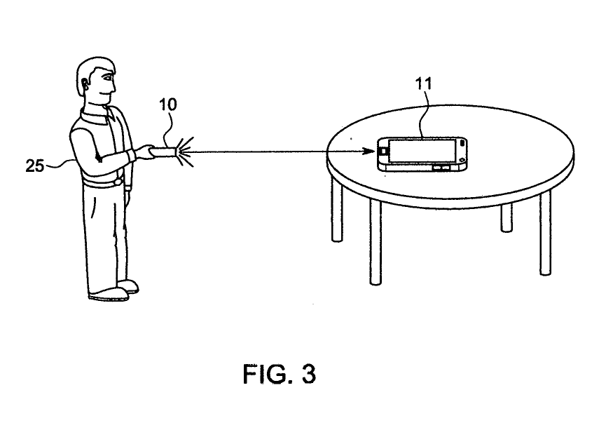

FIG. 3 illustrates a User 25 using the SRH 10 to access his mobile phone 11 remotely via the SRH 10 (frontside).

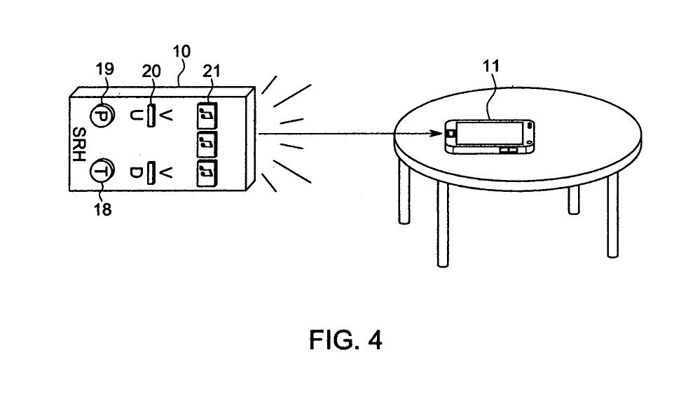

FIG. 4 illustrates the features and functions the SRH 10 (Frontside) will be able to via pre-programmable software code as well as Bluetooth technology carryout on a Smartphone 11. The SRH 10 (Frontside) will turn on and off the phone's music 21 up to 3 (three) separate sources. It will be able to Power 19 the mobile phone on and off and activate via a button 18 a “Find my phone” signal that will cause the mobile phone to emit a “here I am sound” thus the User can then locate a out of sight phone.

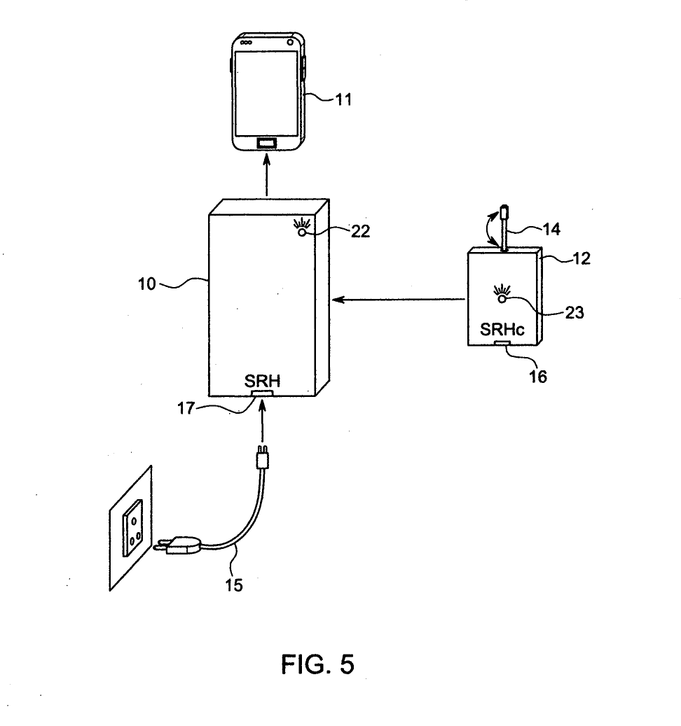

FIG. 5 illustrates the SRH 10 (Frontside) and it shows the charging indicator light 22 that will let the User know the unit is charging and when it is done. It is further illustrated that the SRH 10 has a Input USB port 17 so that a USB micro wall charger cable 15 can be plugged in in order to charge the SRH 10. It is further illustrated that the SRH 10 attach device the SRHc 12 also is equipped with an Input USB port 16 in order to be able to charge the SRHc 12 and an Output port 14 with a built-in USB micro cable 14 in order to be able to connect to a mobile phone 11 and charge it. It also is equipped with a charging indicator light 23.

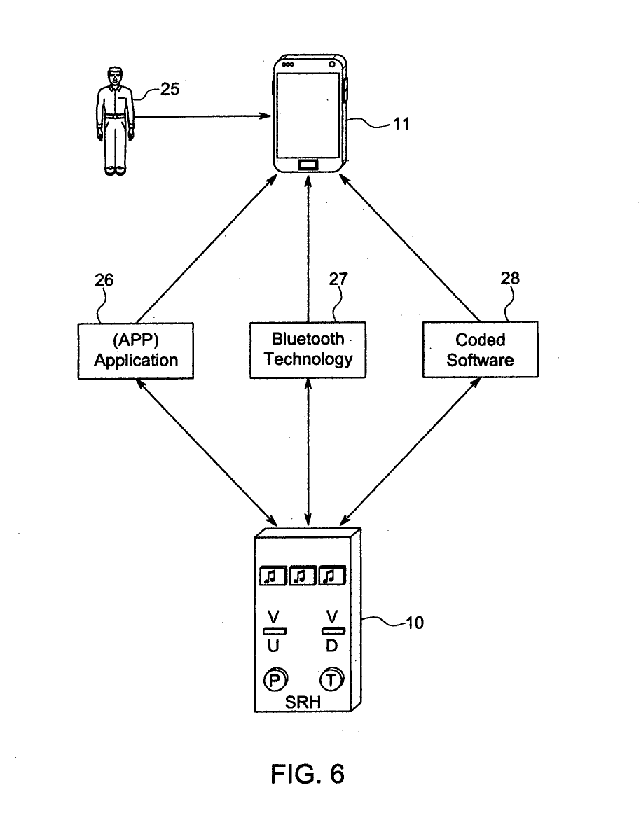

FIG. 6 illustrates the SRH 10 connecting to a Smartphone 11 via a SRH 10 application 26 that will need to be installed into User's 25 Smartphone 11 also via Bluetooth technology 27 and via Coded SRH 10 Software programming 28.

1. The SRH (Smartphone Remote Control) is a Software technology run hardware that will be able to operate a Smartphone from a short distance ranging from 5-8 feet.

2. The SRH of claim 1 is equipped with a smaller hardware piece, the SRHc, that is physically attached to the back of the SRH that is also run by software technology and will be able to charge a Smartphone on a limited bases.

3. The SRH of claim 1 and its piggyback attachment will both be able to be charged independently of each other as both have USB charging ports.

4. The SRN's attachment of claim 2 SRHc comes with its own micro USB cable for quick access and connection to the mobile phone for charging purpose.

5. The SRH of claim 1 and the SRHc both will be equipped with color lights to indicate charging mode.

6. The SRH of claim 1 will allow for remote operation of a Smartphone's:
(a) music source by starting and stopping it,
(b) controlling its volume level (up or down),
(c) allowing for a unique sound to emit from the Smartphone its programmed to once activated by the SRH in order to locate the device if it is out of the Owner's sight within a reachable distance via a button press,
(d) turning the Smartphone on and off and
(e) via the SRH's attached hardware piece, the SRH′c, the User can charge his Smartphone with a limited charge to keep it on for a while longer.

7. The SRH of claim 1 Software technology is coupled with its own application that is downloaded to a Owner's/User's Smartphone in order to be able to connect with each other and operate the functions of the SRH.
